(19) United States
(12) Patent Application Publication
(10) Pub. No.: US 2024/0424863 A1
(43) Pub. Date: Dec. 26, 2024

(54) METHOD AND SYSTEM FOR CONTROLLING A VEHICLE CLIMATE CONTROL SYSTEM BASED ON A SUN/SHADE WITHIN THE VEHICLE

(71) Applicant: FCA US LLC, Auburnn Hills, MI (US)

(72) Inventors: Travis Bechtel, Goodrich, MI (US); Mark E Stout, II, Auburn Hills, MI (US)

(21) Appl. No.: 18/341,327

(22) Filed: Jun. 26, 2023

(51) Int. Cl. B60H 1/00

(52) U.S. Cl. CPC B60H 1/0075; B60H 1/00742; B60H 1/00864

(57) ABSTRACT

A method of operating a climate control system includes determining a sun/shade line within a vehicle based on thermal images from a thermal image device within the vehicle. The method further includes controlling a climate control system based of the sun/shade line.

### FIELD

The present disclosure relates to controlling a climate control system of a vehicle and, more particularly, to a method and system for controlling a climate control system based upon a sun/shade within the vehicle.

### BACKGROUND

This section provides background information related to the present disclosure which is not necessarily prior art.

Climate control system in vehicles require input for controlling the conditions in the occupant area. Vehicles may have climate control systems for one or more passengers. That is, the climate control system may have individual controls for controlling the driver front seat, the passenger front seat and one or more rear seats. Climate control settings include the temperature and airflow, or fan speed desired by the occupant. The vents through which the conditioned air travels may also be directed at or away from the occupant or the different parts of the vehicle.

In many vehicles, the climate control system has settings that are automatically adjusted. The occupant merely sets the desired temperature, and the fan speed is controlled automatically to achieve the desired temperature in the least amount of time. Such systems do not account for variations in the amount of heat and other occupant conditions.

Providing automatic adjustments to the thermal state of an occupant would reduce the driver distract and increase the comfort of the driver based on various conditions.

Infrared (IR) sensors have been used to detect various conditions in automotive vehicles. One example is the detection of the presence of a human within the passenger compartment. An alert may be sent to the passenger to prevent, for example, a child from being left in a hot vehicle. Infrared sensors have also been used to detect the thermal pattern of an occupant's face and control the climate control system based thereon. One problem with such a system is that other factors affect the comfort of the occupants of the vehicle.

### SUMMARY

This section provides a general summary of the disclosure, and is not a comprehensive disclosure of its full scope or all of its features.

The present disclosure uses thermal imaging to provide further control of the climate control system based upon the determination of a sun/shade line.

In one aspect of the disclosure, a method of operating a climate control system includes determining a sun/shade line within a vehicle based on thermal images from a thermal image device within the vehicle. The method further includes controlling a climate control system based of the sun/shade line.

In another aspect of the disclosure, a system for controlling a climate control system includes a thermal image device and a controller programmed to determine a sun/shade line within a vehicle based on thermal images from a thermal image device within the vehicle and programmed to control a climate control system based of the sun/shade line.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a block diagrammatic representation of a vehicle having a climate control system.

FIG. 1B is a perspective view of one example of a vent in an open position.

FIG. 1C is a perspective view of a vent in a closed position.

FIG. 2 is a detailed block diagrammatic view of a climate control system.

FIG. 3 is a flowchart of a method for operating the climate control system.

FIG. 4A is a top view of a vehicle relative to the sun.

FIG. 4B is a side view of a vehicle relative to the sun.

FIG. 4C is a front view of an occupant having sun/shade lines imposed thereon.

FIG. 4D is a front thermal image view of the occupant of FIG. 4A.

FIG. 4E is a side thermal image view of the occupant of FIGS. 4B and 4C.

Corresponding reference numerals indicate corresponding parts throughout the several views of the drawings.

### DETAILED DESCRIPTION

Example embodiments will now be described more fully with reference to the accompanying drawings.

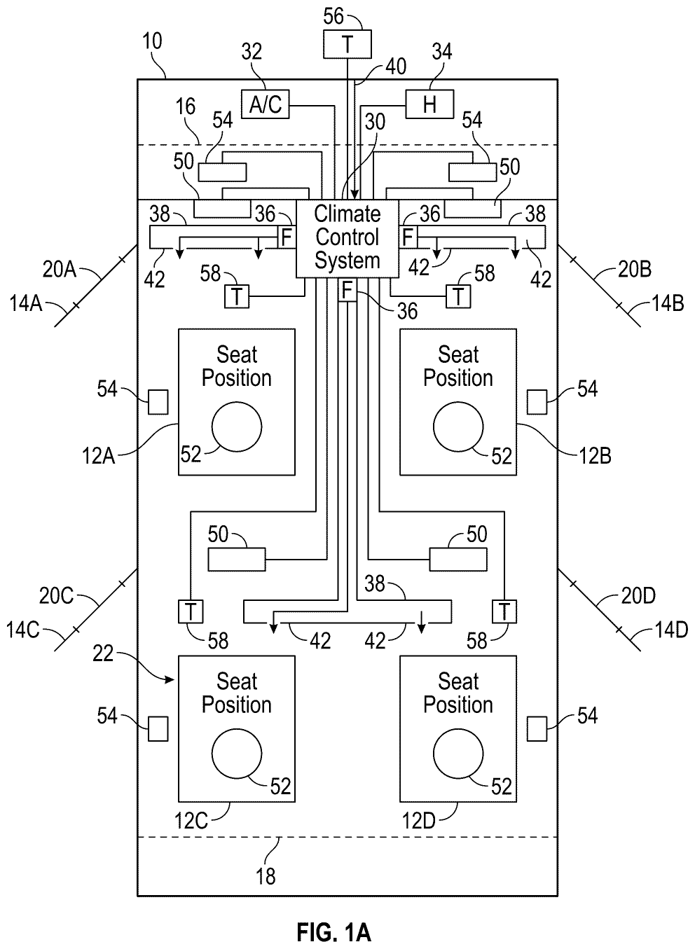

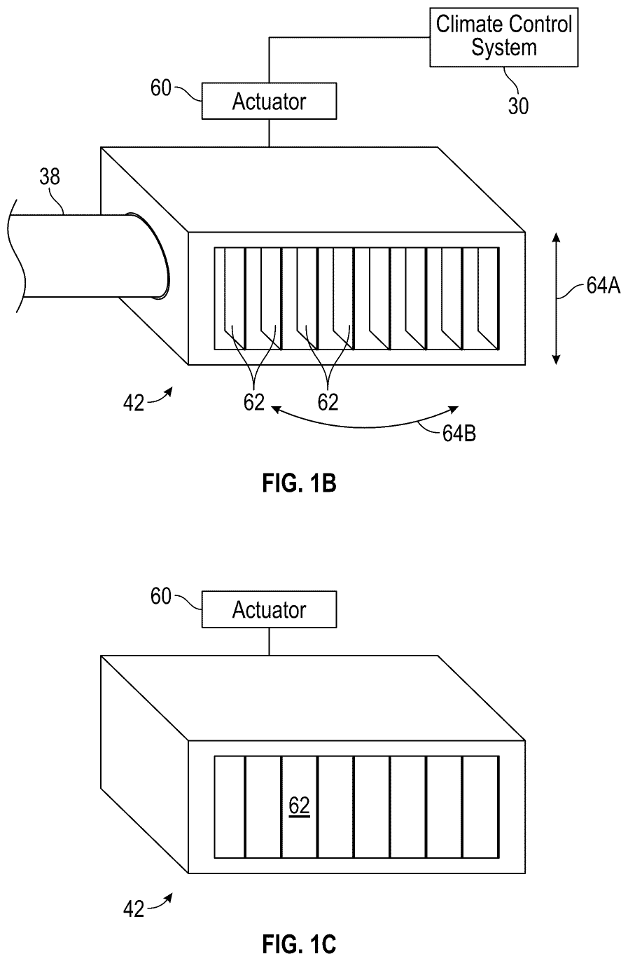

Referring now to FIG. 1A, a vehicle 10 is illustrated having a plurality of seating positions 12A, 12B, 12C and 12D. Seating position 12A, in this example, is the driver position. The seating position 12B is the front passenger position. Seat position 12C is the rear left passenger position and seat position 12D is in the rear right passenger position. The vehicle 10 has a plurality of doors 14A, 14B, 14C and 14D adjacent to each of the seat positions 12A-12D. Of course, more seat positions such as a position between seat positions 12A and 12B, between 12C and 12D and behind 12C and 12D may also be provided in a vehicle. The teachings set forth herein apply equally to the seating positions 12A-12D illustrated and seating positions not illustrated.

The vehicle 10 also has a windshield 16, a rear window 18 and door windows 20A-20D that correspond to the doors 14A-14D, respectively. The amount of solar load from sunshine entering the passenger compartment 22 varies considerably based upon the position and angle of the sun relative to the vehicle. Of course, other windows including a sunroof may be included within the vehicle.

A climate control system 30 is also included within the vehicle. The climate control system 30 is in communication with an air conditioning system 32 and a heater system 34 to control the outlet temperature of the vents. The air conditioning system 32 may comprise an air conditioning compressor coupled to the engine by way of a belt. The air conditioning system 32, in an electric vehicle, may be an electric motor that operates a compressor to generate cooling fluid.

The heater system 34 may be coupled to an engine to remove heat from the engine and provide it to the passenger compartment 22. The heater system 34 may also be a resistive heater or combinations of a resistive heater and an engine heater. One or more fans 36 are used to move air from the air conditioning system 32, the heater system 34 and possibly from air from outside the vehicle as well. The air from the outside of the vehicle is indicated by the arrow 40. The fans 36 communicate air through the ducts 38. Each individual position may have its own duct or, for example, the seat positions 12C and 12D in the rear of the vehicle may spare a common duct. Various possibilities are available for different vehicles.

The ducts 28 have vents 42 through which controller air is communicated to the passenger compartment 22. Two vents 42 are illustrated directed to the seat positions 12A and 12B. One vent is directed at the seating positions 12C and 12D. However, various numbers of vents in various positions may be provided such as at the legs, at various positions of the torso, the arms and the like. The direction of the vents may be controlled laterally longitudinally, and vertically. Inputs to the climate control system 30 include thermal image devices such as thermal cameras 50 that are positioned to view the seating positions 12A-12D. The thermal cameras 50 generate thermal camera signals corresponding to a thermal image of the seating positions 12A-12D. That is, the thermal cameras 50 generate thermal images of the occupants 52 and various aspects of the occupants 52 as will be described in further detail below. The thermal cameras 50 generate thermal image signals that are communicated to the climate control system 30 and are processed by a microprocessor therein. Various filtering, analysis and machine learned or neural network outputs are used to control the various aspects of the climate control system including the air conditioning 32, the heater system 34, the fans 36 and the like.

The climate control system 30 also is coupled to sun load sensors 54. The sun load sensors 54 generate a sun load signal corresponding to the sun load at the position at which the sun load sensors 54 are mounted. Other sun load sensors 54 are not connected to the climate control system as illustrated in FIG. 1A. Those in the art will understand that they are actually coupled to the climate control system 30 but for simplicity of illustration purposes are not illustrated as such. The sun load sensors 54 may be positioned in front of the first and second seating positions 12A, 12B, on the sides of the seating positions 12A, 12B. in addition, sun load sensors 54 may be located in other systems such as on the outside of seating positions 12C, 12D.

An external temperature sensor 56 may generate a temperature signal corresponding to the exterior temperature of the vehicle and communicate the exterior temperature signal to the climate control system 30.

Although one thermal camera 50 is shown for each seat position 12A-12D, multiple cameras 50 in multiple positions may be used.

Cabin air temperature sensors 58 may be located at various positions throughout the passenger compartment 22. The temperature sensors 58 generate a temperature signal adjacent to the seating positions 12A-12D.

Referring now to FIGS. 1B and 1C, the vents 42 illustrated in FIG. 1A are merely represented by openings. The vents 42 may be coupled to a vent actuator 60. The vent actuator 60 is in communication with the climate control system 30. The climate control system 30 may control the actuator 60 to move the vents 42 in desired positions. That is, the vents 42 may have louvers 62 that are movable in an upward and downward position as well as in a rightward or leftward direction as illustrated by arrows 64A, 64B, respectively. That is, the actuator 60 may move the louvers 62 into various positions including a closed position as illustrated in FIG. 1C. By opening and closing the louvers 62, directing the louvers 62, controlling the fan speed, controlling the air temperature within the ducts 38, occupant comfort can be controlled precisely. Of course, multiple actuators 60 and multiple vents 42 may be located at various positions around the occupants 52.

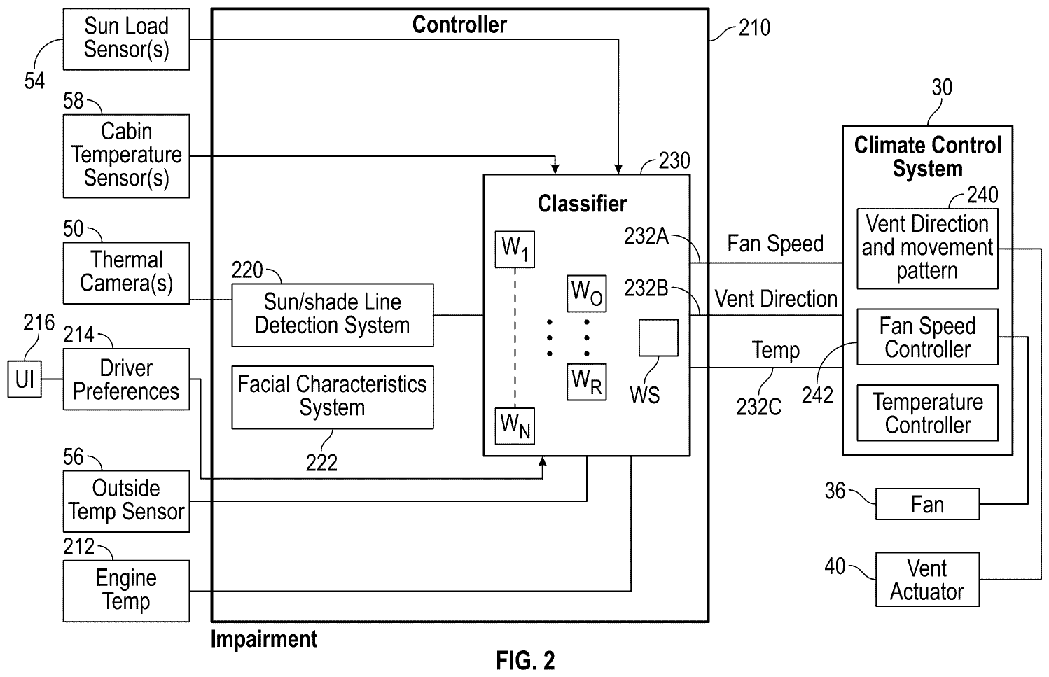

Referring now to FIG. 2, the various sensors are illustrated coupled to a controller 210. The controller 210 is programmed to perform various determinations and generate various intermediate signals used to ultimately control the climate control system. The sensors include the sun load sensors 54, the cabin temperature sensors 58, the thermal cameras 50 and other sensors including an engine temperature sensor 212. The engine temperature sensor 212 may be provided in internal combustion engine systems. However, the engine temperature sensor 212 may be eliminated in electric vehicles. Driver preferences 214 may be controlled by a user interface 216. For example, driver preferences 214 may include the desired temperature of the vehicle. Driver preferences 214 may be controlled through the user interface 216 which may be touch screen, dials, buttons or the like. The driver preferences 214 may include, but are not limited to, the desired position or amount of blowing of the vent air to the facial region of an occupant, the temperature of the occupant, a temperature differential for the occupant, such as but not limited to warmer at the feet and cooler at the face. Ultimately, the signals from the sensors 54-58 and the driver preferences 214 and engine temperature 212 are provided to the controller 210. Ultimately, various thermal characteristics for the occupants 52 of the vehicle may be determined. The thermal characteristics together with the sun load sensor signals, the cabin temperature sensor signals, the driver preferences, the outside temperature signals and the engine temperature signals may be used to ultimately control the climate control system.

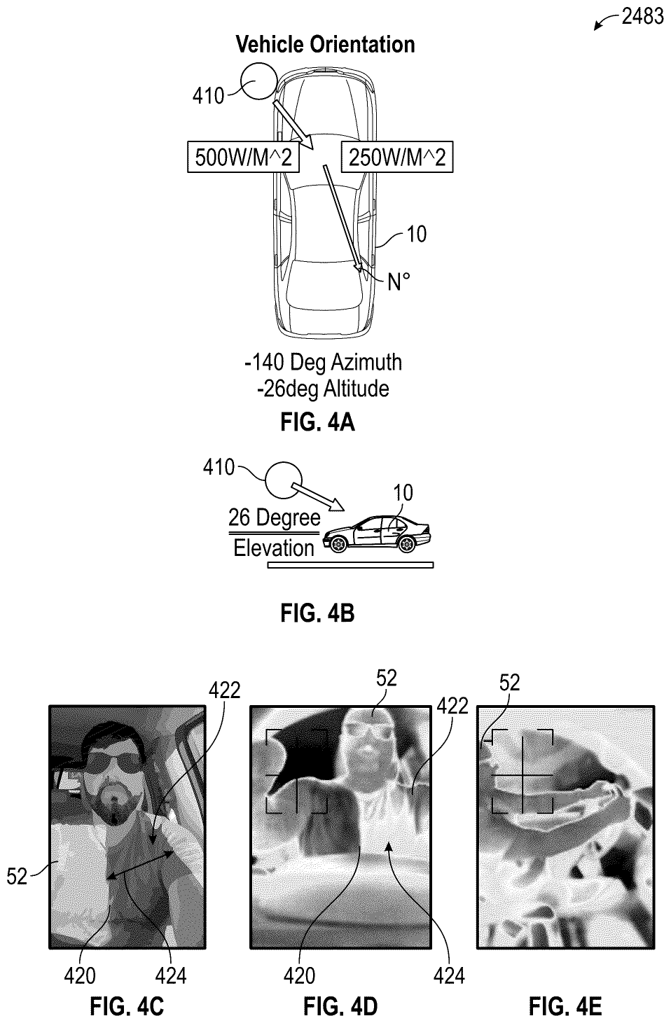

The controller 210 has various systems therein that are used for determining the thermal characteristics for the occupant. A sun/shade line detection system 220 is disposed within the controller 210. The sun/shade line detection system 220 receives thermal images from the thermal camera 50. The sun/shade line may be formed by a shadow from components within the vehicle. For example, the A-pillar may cast a shadow on the occupant wherein a part of the occupant is in the direct sunlight while part of the occupant is shaded by the A-pillar. Other part of the vehicle may have the sun/shade line determined thereon such as but not limited to the B pillar, console, seat belt, anything near, adjacent to, or straddling occupant. Detecting sun/shade lines on these surfaces may help the system avoid being fooled by baggy clothing or the occupants own heat signature The differential temperature of the vehicle occupant may therefore be sensed in the thermal images and compensated for by the climate controller fan speed, vent direction and temperature. An example of a thermal image sun/shade line is set forth in FIG. 4B below. The system may also act as a supplement to the sun load sensing system already present on the vehicle. The current systems are not able to differentiate between sun incidence angles that are the same relative to the sensors but different relative to cabin surfaces (high versus low incidence, which impacts cabin heating as well).

The sun load sensor signals, the cabin temperature sensor signals, driver preferences, the outside temperature and the engine temperature may all be provided to the classifier 230 to adjust the fan speed, vent direction and temperature within the climate controller so that the occupant is comfortable according to their driver preferences. The driver preferences, as mentioned above, may be set in the driver preferences block 214. A facial characteristic system 222 may be provided within the controller 210. The facial characteristic system 222 may obtain images from the thermal cameras 50 to identify an occupant and automatically set the preferences for the particular occupant. The neural network uses a plurality of weights in multiple layers. Three layers are illustrated in the classifier 230. However, multiple layers may be provided. The neural network, in this example, has layers that have weights W1-WN, WO-WR and WS to provide the final signals such as the fan speed signal 232A, the vent direction 232B and the temperature signal 232C. Ultimately, the climate control system 30 has a vent direction and movement pattern controller 240 and a fan speed controller 242 that control the fan 36 and the vent actuator 60 based upon the signals 232A-232C,

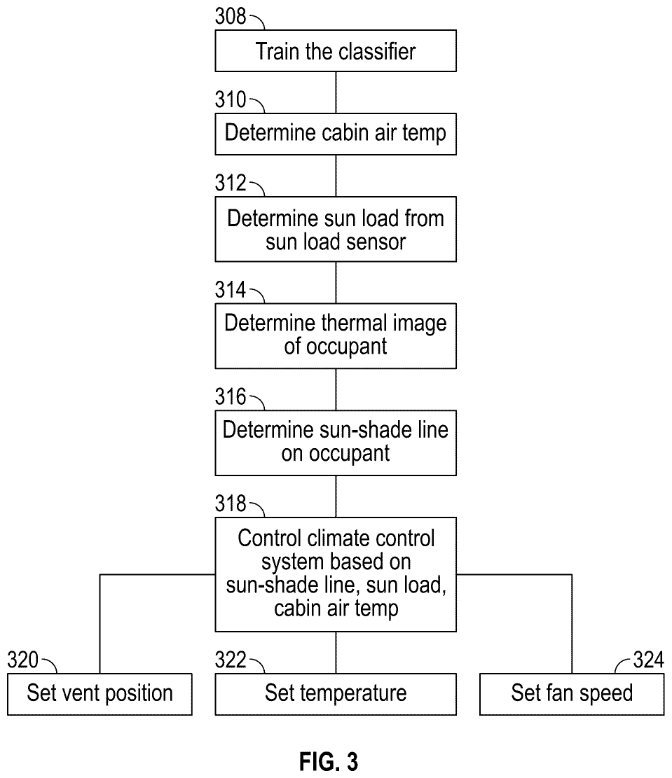

Referring now to FIG. 3, a method of operating the controller 210 and the climate controller 30 is set forth. The method includes training the classifier 308. The classifier 308 may be trained with a plurality of training thermal images until the weights within the classifier 308 are adjusted to provide an adequate response and accuracy for identifying thermal images and the sun/shade lines therein.

In step 310, the cabin air temperature is determined from the cabin air temperature sensor 58. As mentioned above, one or more cabin air temperature sensor 58 proximate the occupant or seating positions may be obtained.

In step 312, a sun load signal from one or more sun load sensors may detect the sun load on the vehicle. As mentioned above, a plurality of sun load sensors, some adjacent to or in front of the occupants, may be used. The sun load sensor may allow some directionality of the energy from the sun to be determined. In step 314, one or more thermal images of the occupant is obtained. In step 316, the thermal images are processed within the sun/shade line detection system 220 to determine the sun/shade line relative to the occupant. The sun/shade line for the occupant position is communicated to the classifier 230. In step 318, the classifier determines the climate control settings based upon the sun/shade line, the sun load and the cabin air temperature.

In step 320, the climate control system is used to set the vent position in step 320, set the temperature in step 322 and set the fan speed in step 324.

Referring now to FIGS. 4A and 4B, the vehicle 10 is illustrated relative to the sun 410. A top view is illustrated in FIG. 4A and side view is illustrated in FIG. 4B. The amount of power on the vehicle is illustrated as 500 watts per M². However, the glass is tinted glass and therefore 200 watts per M2 enters the occupant compartment. The sun is illustrated at 26° in elevation and at −140° in azimuth.

Referring now to FIG. 4C, a front picture of an occupant is illustrated. A sun/shade line 420, 422 shows the shaded portion 424. That is, the shaded portion 424 is bounded by two sun/shade lines 420, 422.

Referring now to FIGS. 4D and 4E, the occupant 52 is illustrated in front and side views respectively. The thermal image shows respective sun/shade lines 420, 422 along with a cooler portion corresponding to the shaded portion 424. The size view in FIG. 4D shows the occupant in heated zones with both arms in the heated zones. Therefore, the climate controller may adjust the fan, temperature and vent direction to concentrate on the heated zones of the occupant.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations.

What is claimed is:

1. A method comprising:
determining a sun/shade line within a vehicle based on thermal images from a thermal image device within the vehicle; and
controlling a climate control system based of the sun/shade line.

2. The method of claim 1 wherein determining the sun/shade line comprises determining the sun/shade line on an occupant.

3. The method of claim 1 further comprising determining a cabin air temperature signal and wherein controlling the climate control system comprises controlling the climate control system based on the cabin air temperature signal and the sun/shade line.

4. The method of claim 1 further comprising determining a sun load signal and wherein controlling the climate control system comprises controlling the climate control system based on the sun load signal and the sun/shade line.

5. The method of claim 1 further comprising determining a cabin air temperature signal determining a sun load signal and wherein controlling the climate control system comprises controlling the climate control system based on the cabin air temperature signal, the sun load signal and the sun/shade line.

6. The method of claim 1 wherein controlling the climate control system comprises controlling a fan speed.

7. The method of claim 1 wherein controlling the climate control system comprises controlling at least one of a lateral vent direction and a longitudinal vent direction.

8. The method of claim 1 further comprising controlling an outlet temperature of the climate control system.

9. The method of claim 1 further comprising determining driver preferences, outside temperature and engine temperature, and controlling the climate control system based on the driver preferences, the outside temperature and the engine temperature.

10. A system for controlling a climate control system comprising:
a thermal image device;
a controller programmed to determine a sun/shade line within a vehicle based on thermal images from a thermal image device within the vehicle, and
programmed to control a climate control system based of the sun/shade line.

11. The system of claim 10 wherein therein the controller is programmed to determine the sun/shade line on an occupant.

12. The system of claim 10 wherein the controller is programmed to determine a cabin air temperature and wherein control the climate control system based on the cabin air temperature and the sun/shade line.

13. The system of claim 10 wherein the controller is programmed to a sun load and control the climate control system based on the sun load and the sun/shade line.

14. The system of claim 10 wherein the controller is programmed to determine a cabin air temperature, determine a sun load and control the climate control system based on the cabin air temperature, the sun load and the sun/shade line.

15. The system of claim 10 wherein the controller is programmed to control a fan speed.

16. The system of claim 10 wherein the controller is programmed to control at least one of a lateral vent direction and a longitudinal vent direction.

17. The system of claim 10 wherein the controller is programmed to control an outlet temperature of the climate control system.

18. The system of claim 10 wherein the controller is programmed to determine driver preferences, outside temperature and engine temperature, and is programmed to control the climate control system based on the driver preferences, the outside temperature and the engine temperature.
